(19) United States
(12) Patent Application Publication
(10) Pub. No.: US 2016/0271012 A1
(43) Pub. Date: Sep. 22, 2016

(54) MULTI-FUNCTIONAL PERSONAL HYGIENE SYSTEM

(71) Applicant: LIU QING XU, Montreal (CA)

(72) Inventor: LIU QING XU, Montreal (CA)

(73) Assignee: LIU QING XU, MONTREAL (CA)

(21) Appl. No.: 15/068,589

(22) Filed: Mar. 13, 2016

(30) Foreign Application Priority Data
Apr. 7, 2015 (CA) 2887179

(51) Int. Cl. A61H 33/10; A47K 3/28; F16K 31/06; A61H 33/00; A61H 33/06

(52) U.S. Cl. CPC A61H 33/10; A61H 33/0087; A61H 33/066; A61H 33/6005; A61H 33/6089; F16K 31/06; A47K 3/28; A61H 2033/0012; A61H 2201/5043; A61H 2033/061; A61H 2033/068

(57) ABSTRACT

The present invention provides a multi-functional personal hygiene system. This multi-functional personal hygiene system has a similar structure to a walk-in bathtub, the difference of the main structure between them is that, the former has a cover assembly on the tub, but the latter does not have it. The multi-functional personal hygiene system is equipped with a sauna system, a water jet system, a at least one massage & scrub disk assemblies, a shower mode, a bath mode, a tub clean system and a media center. The tub clean system makes the tub cleaning easier and more simply. The media center brings the users some information about the multi-functional personal hygiene system and some entertainment, provides the user some humanization services.

### CROSS-REFERENCE TO RELATED APPLICATIONS

Not applicable

### TECHNICAL FIELD

The present invention relates generally to a tub equipped with a sauna system, a water jet system, at least one massage & scrub disk assemblies, a tub clean system and a media center.

### BACKGROUND OF THE INVENTION

It is well known that a walk-in bathtub is safe and comfortable. It allows the user to walk into and out of the bathtub without a risk of slips and falls. Its back place has been raised and created a built-in seat, some water jet nozzles have been installed on the tub walls. The user feels safe and comfortable during sitting on the built-in seat and getting a hydraulic massage by the water jet. Although the walk-in bathtub has these advantages mentioned above, it still has some faults. Firstly, it is only attractive to the users with old ages or physical disabilities, but the independent persons are not interested in these functions. Secondly, the walk-in bathtub makes a bathing very expensive because the bathing consumes lots of warm water, especially, used in some water shortage countries and areas. Thirdly, its open structure causes some problems too, for example, much heat loses. The users, especially those who are in poor health, easily catch a cold. These above reasons badly affect the commercialization of the walk-in bathtub.

### BRIEF SUMMARY OF THE INVENTION

The present invention provides a multi-functional personal hygiene system not only for the users who have physical limitations that make it difficult or dangerous to climb into and out of a regular bathtub, but also for those who are in good health and independent. This invention makes the personal hygiene more simply and brings them more health, more beauty, more comfort and more pleasure in addition to the safety.

This multi-functional personal hygiene system has a similar structure to the walk-in bathtub, the difference of the structure between them is that, the former has a cover assembly on the tub, but the latter does not have it. The multi-functional personal hygiene system is equipped with more systems, such as the sauna system, the water jet system, the at least one massage & scrub disk assemblies, a shower mode, a bath mode and the tub clean system. The sauna system makes the user more health, the massage & scrub disk assemblies make the user more health and clean the user's back, the shower mode saves lots of warm water and time for the user, the tub clean system makes the tub cleaning automatically and more simply. The media center brings the user much information about the multi-functional personal hygiene system and much entertainment, provides the user some humanization services.

### BRIEF DESCRIPTION OF THE SEVERAL VIEWS OF THE DRAWING

The present preferred embodiment of the invention is illustrated in the accompanying drawings, in which:

FIG. 1 shows a typical example of a walk-in bathtub with an outward swinging side door in accordance with the prior art;

FIG. 2 shows a perspective view of a multi-functional personal hygiene system in the door closed position (work process) in accordance with a preferred embodiment of the present invention;

FIGS. 3A-3E show a perspective view of a multi-functional personal hygiene system in the door opened position in accordance with a preferred embodiment of the present invention;

FIGS. 4A and 4B show a view of the tub of the embodiment of the present invention;

FIG. 5 shows a view of a support frame of the embodiment of the present invention;

FIG. 6 shows a perspective view of a front apron of the embodiment of the present invention;

FIG. 7 shows a perspective view of a side apron of the embodiment of the present invention;

FIGS. 8A˜8C show a perspective view of an access door of a multi-functional personal hygiene system of the embodiment of the present invention;

FIGS. 9A˜9G show a perspective view of a cover assembly in accordance with a preferred embodiment of the present invention;

FIGS. 10A˜10C show a perspective view of a massage & scrub disk assembly of the embodiment of the present invention;

FIGS. 11A and 11B show a perspective view of a water jet nozzle with a wide spraying angle of the embodiment of the present invention;

FIG. 12 shows a flow chart of the embodiment of the present invention;

### DETAILED DESCRIPTION OF THE INVENTION

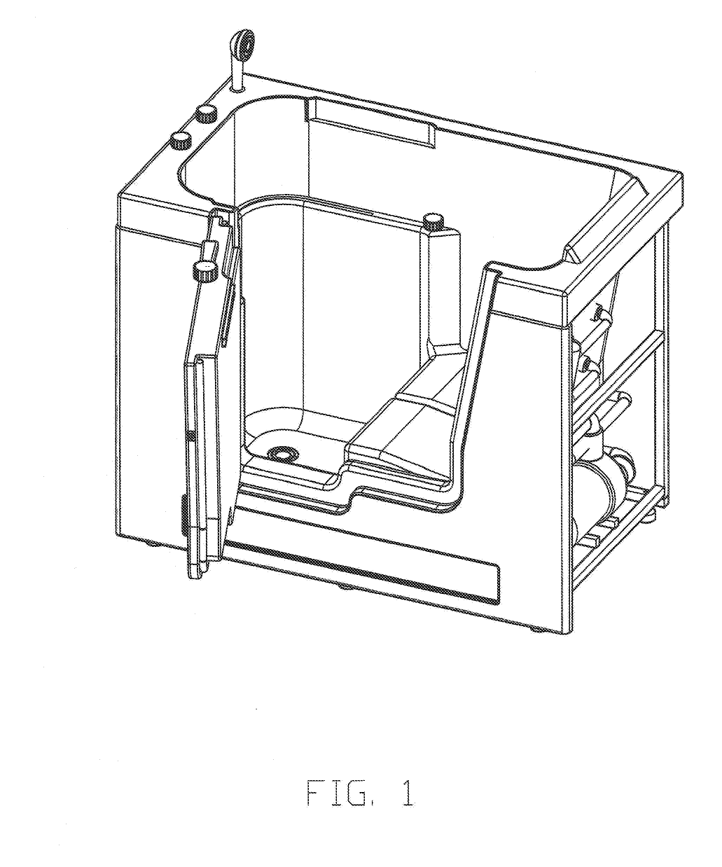

FIG. 1 shows a perspective view of a walk-in bathtub with an outward swinging side door in accordance with the prior art;

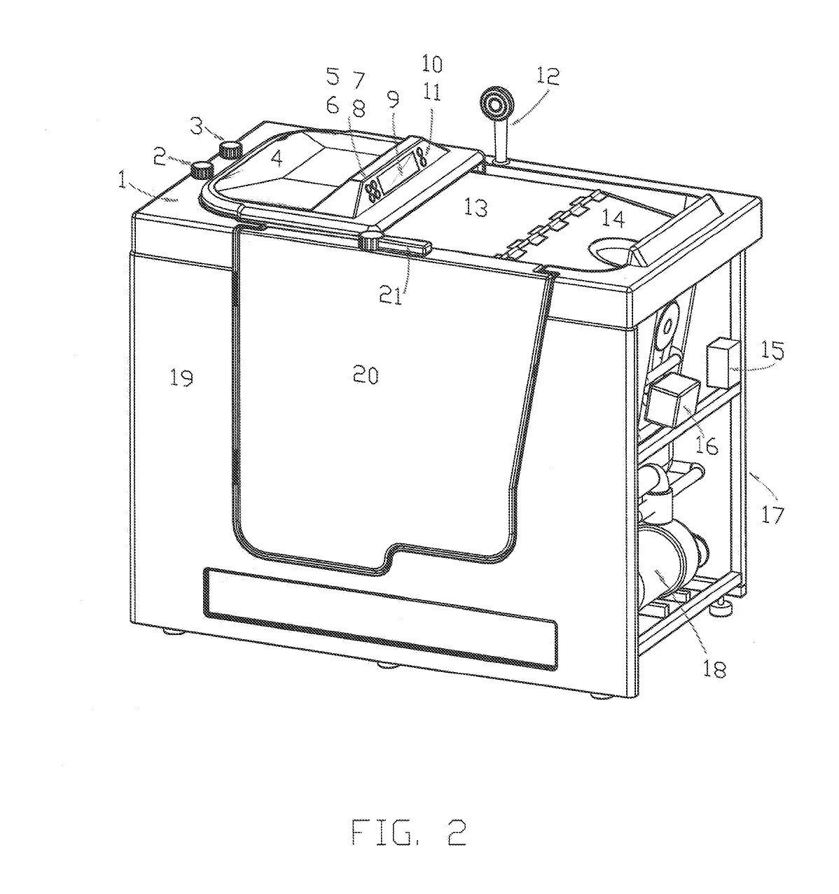

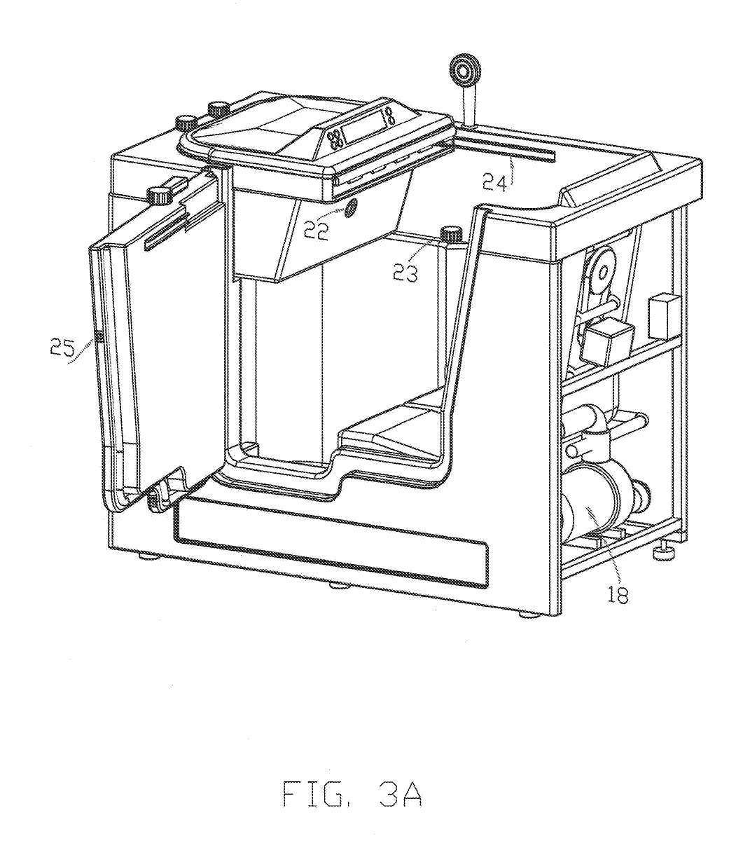

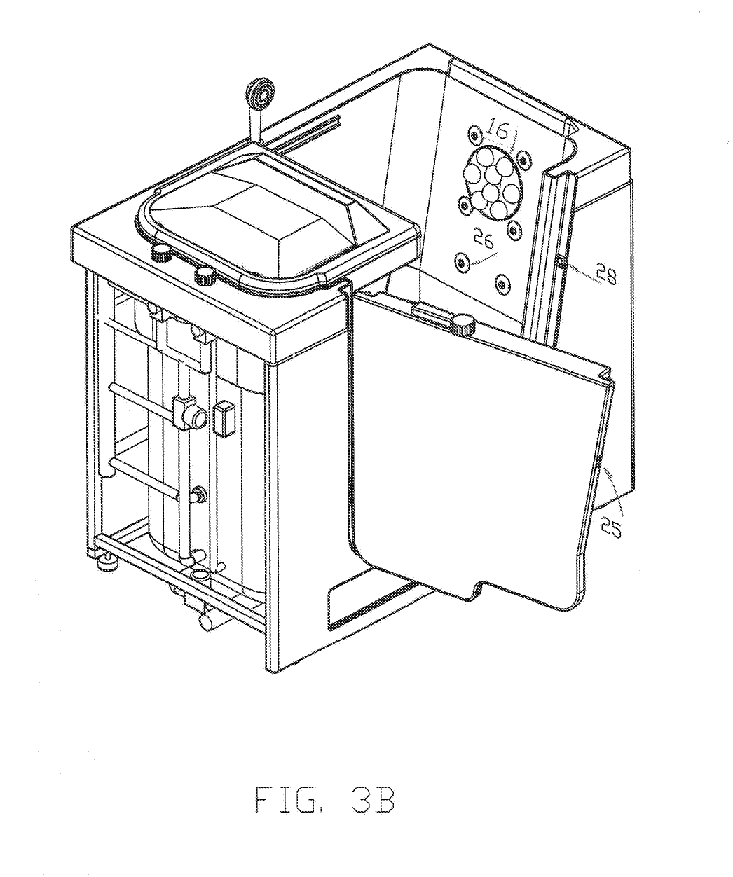

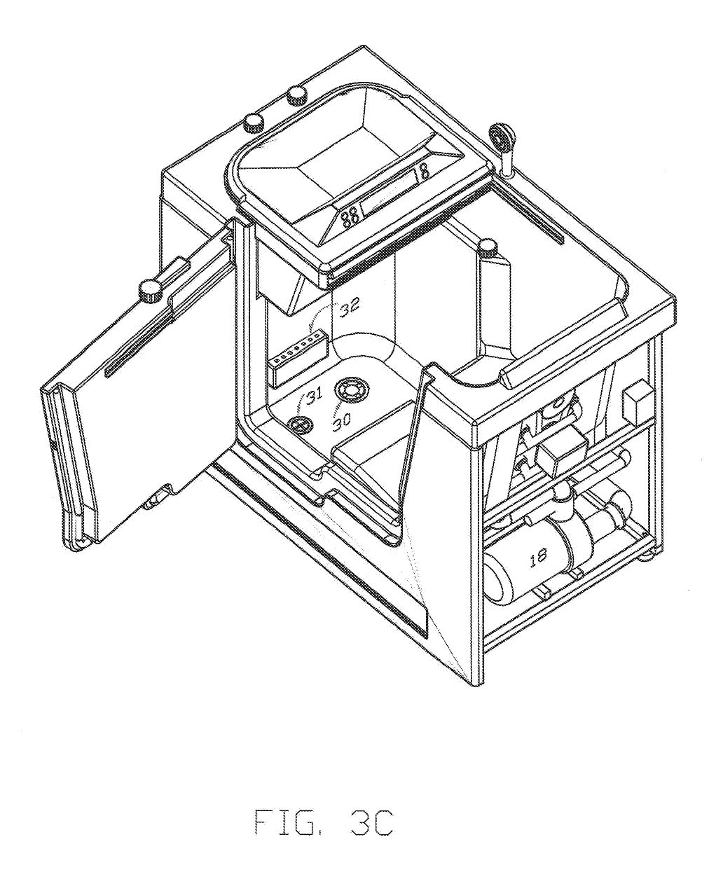

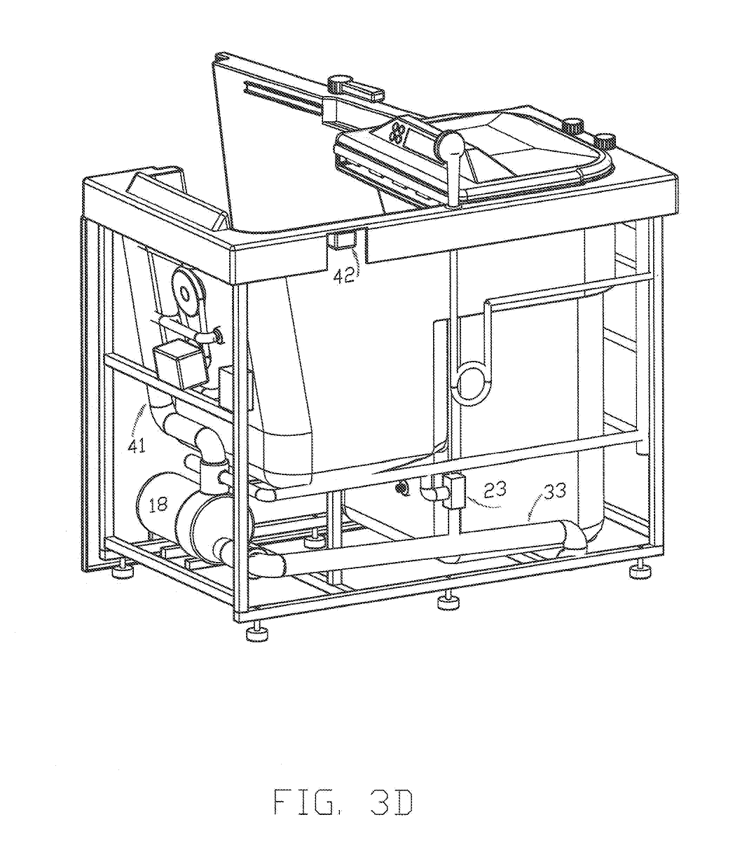

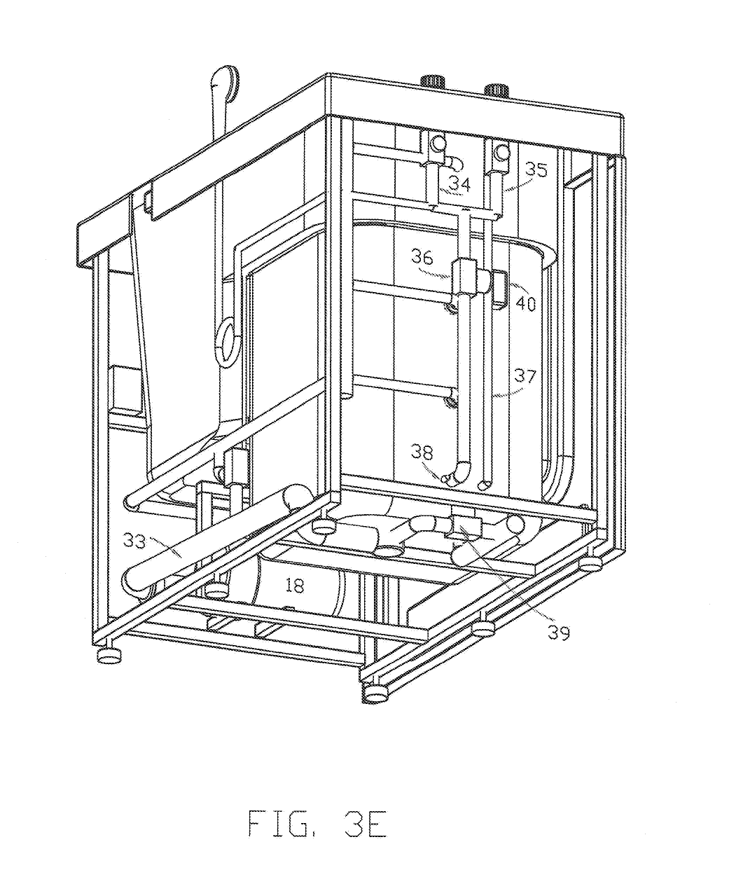

Referring now to FIG. 2, FIG. 2 shows a perspective view of the multi-functional personal hygiene system with a left side door in a closed position with a preferred embodiment of the present invention. Similarly, FIGS. 3A˜3E show a perspective views of the multi-functional personal hygiene system with a left side door in an opened position with a preferred embodiment of the present invention.

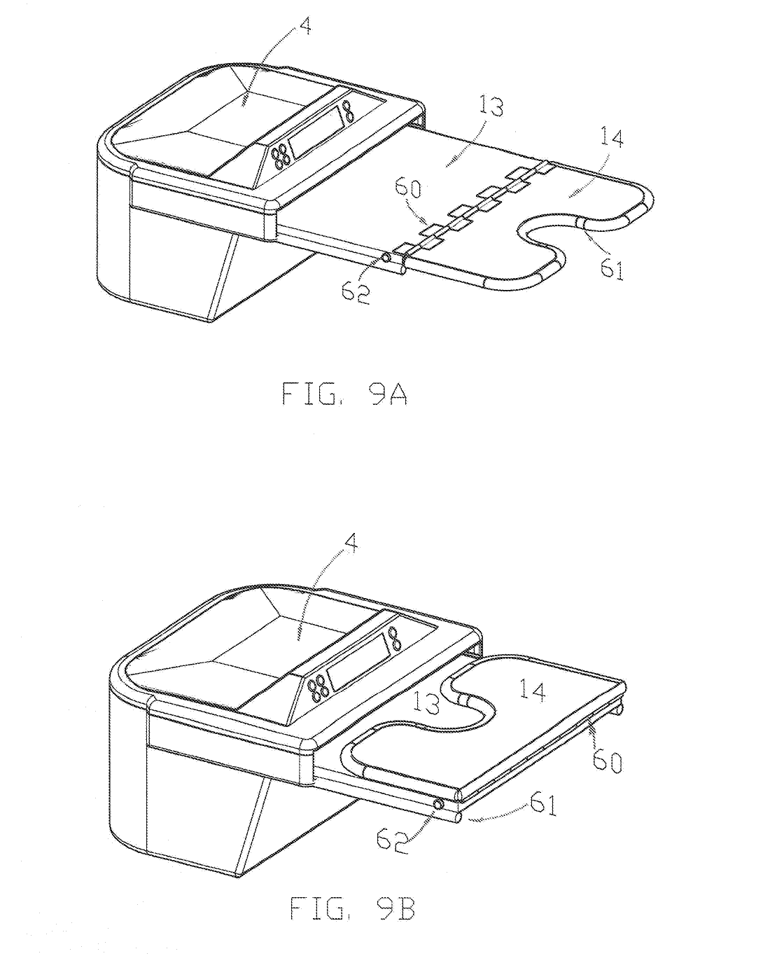

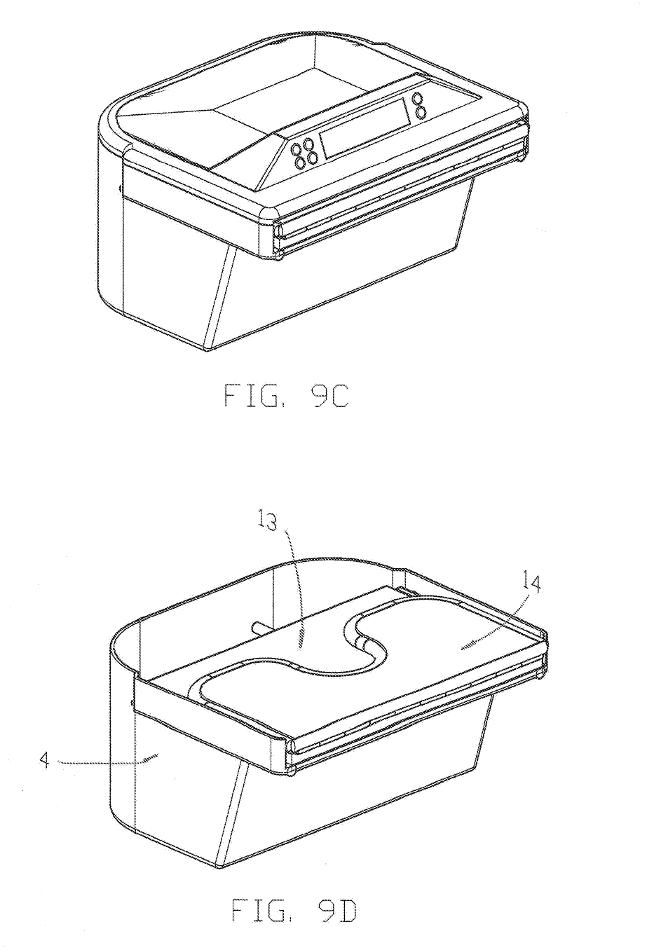

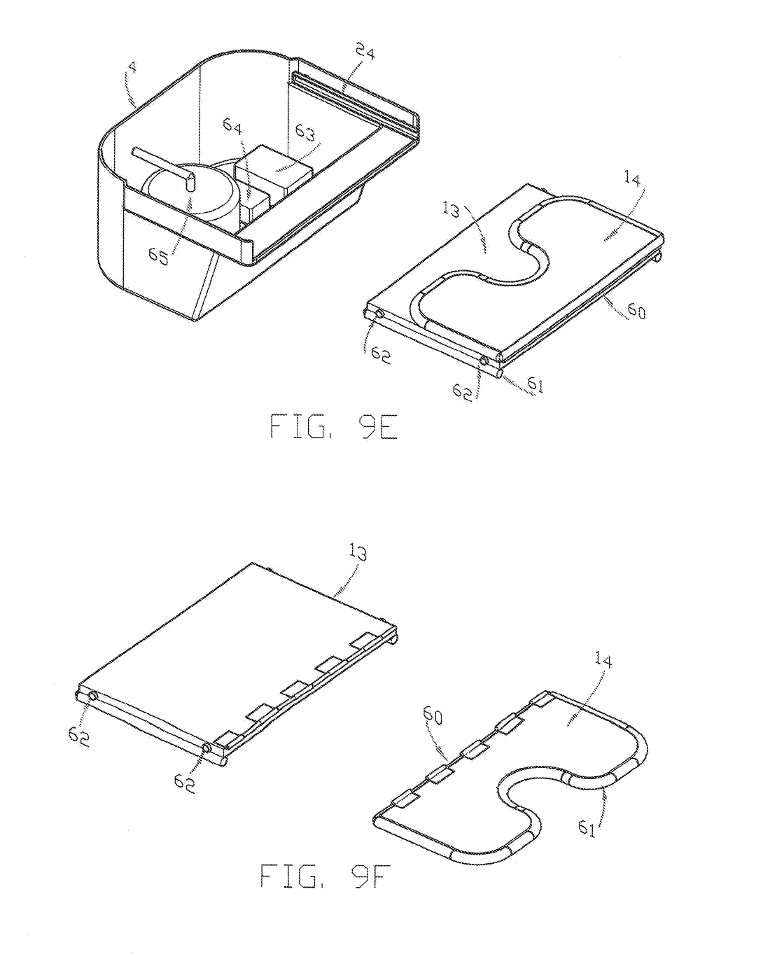

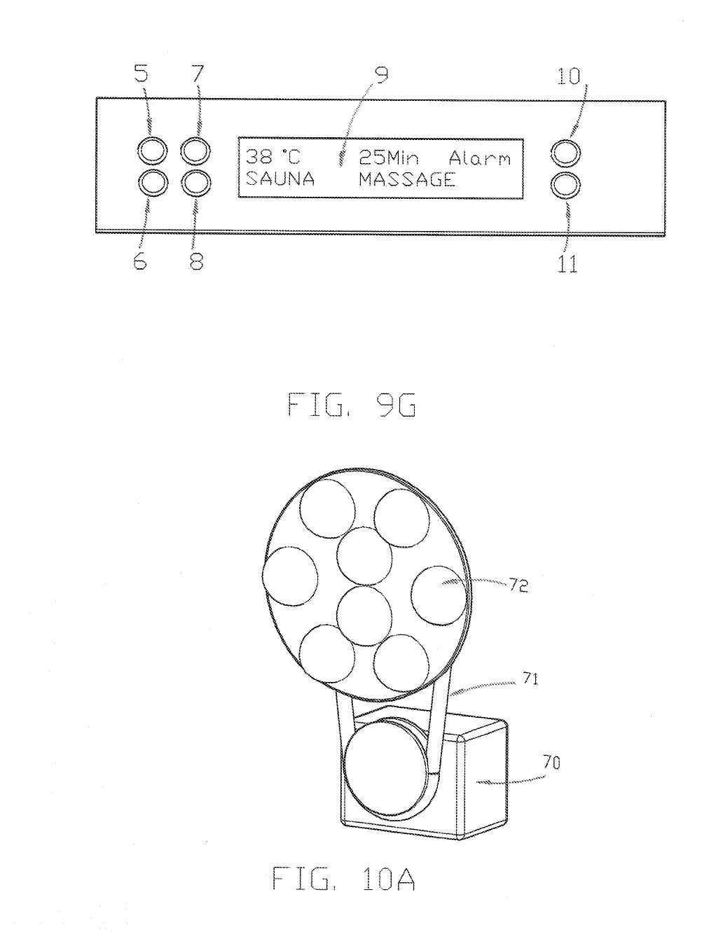

In the example shown (FIG. 2), the multi-functional personal hygiene system mainly comprises the tub 1 where the user takes a sauna, a shower, a bath and a massage, an access door 20 with a door lock 21, a cover assembly which consists of a sliding cover 13, an eversible cover 14 and an immovable cover 4 (best shown in FIGS. 9A˜9G), a massage & scrub disk assembly 16 (best shown in FIGS. 10A˜10C), a support frame 17, the sauna system 65 (shown in FIG. 9E) that is adapted to supply the user a sauna and auxiliary heat the warm water in the tub 1, the water jet system 18 that is adapted to supply the user a shower or bath and a hydraulic massage, a cold water valve 2, a hot water valve 3, a hand held shower head 12, a front apron 19, six control buttons 5, 6, 7, 8, 10 and 11 (best shown in FIG. 9G), a leakage current circuit breaker 15 and the media center 9. It is important that the leakage current circuit breaker 15 is installed in the multi-functional personal hygiene system. It will switch off the whole hygiene system and protect the user in case of leakage of electricity.

Unlike prior art designs, the present invention allows the user to sit down on the built-in seat before entering the tub 1, then turn his or her body safely about 90 degrees and move the legs into the tub 1. In another word, sitting-in is safer than walking-in for the invalids.

As shown in FIGS. 2, 3A, 3C and 3D, for the user to easily operate the multi-functional personal hygiene system of the embodiment of the present invention, six buttons are installed on the top of the multi-functional personal hygiene system, they are named as POWER 10, TUB CLEAN 11, BATH MODE 8, MASSAGE 7, WATER JET 6 and SAUNA 5 (best shown in FIG. 9G). When the user wants to use the multi-functional personal hygiene system, he should do the following operations.

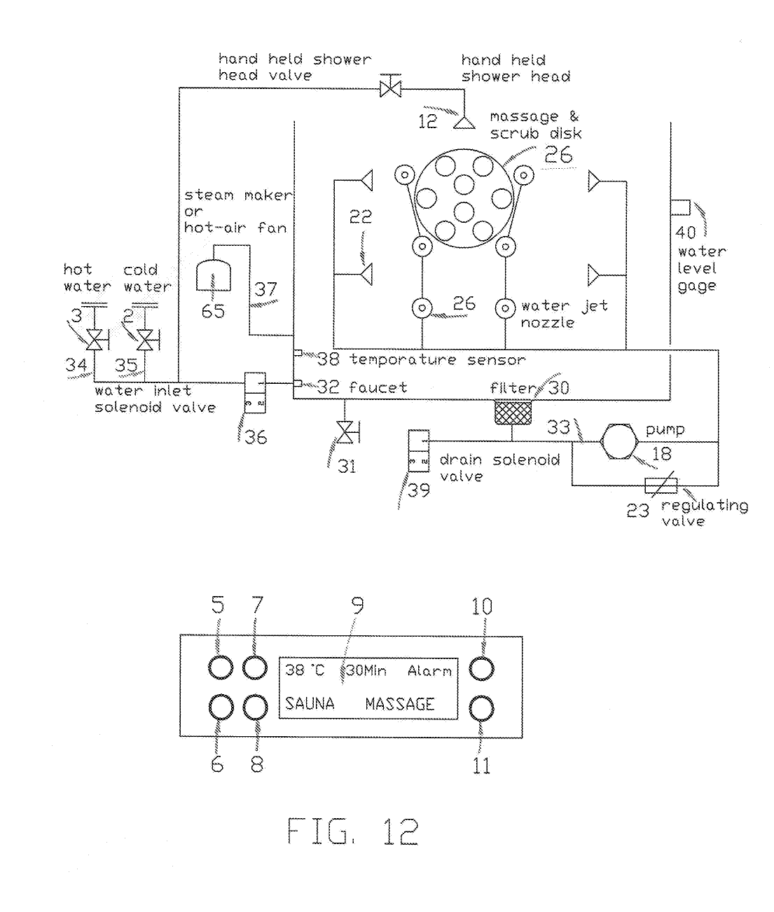

First of all, the power button 10 has to be pressed down, once this button is pressed down, the media center 9 has been started. An instant temperature value inside the tub 1 has been detected by a temperature sensor 38 (shown in FIGS. 3E and 12) and shown on the screen. For a new user, he/she can read some information in the media center 9, such as some information about the sauna, shower, bath and massage. Of course, he/she may read a tub manual in the media center 9 before doing the next operations.

Secondly, the user may press down the tub clean button 11 if he wants to clean the tub 1. Before pressing down this button, he has to close the access door 20, turn the handle 21 and lock the access door 20. The tub clean system is an auxiliary system that cleans the whole hygiene system automatically, saves the tub cleaning labour, and avoids a cross infection between different users, and is controlled by a circuit controller 63 (as shown in FIG. 9E). Once this button 11 is pressed down, the circuit controller 63 will close a drain solenoid valve 39 (normally opened) and open the water inlet solenoid valve 36 (normally closed, as shown in FIG. 3E) at once. The water, coming from a cold water line 35 and a hot water line 34 (as shown in FIG. 3E), passes a faucet 32 (as shown in FIG. 3C), and enters the tub 1 immediately. The water inlet solenoid valve 36 will close when a water level reaches to a predetermined level, the water level is controlled by a water level gage 40 (as shown in FIG. 3E). The tub clean system will not start if the sliding cover 13 and the eversible cover 14 do not cover the tub 1 completely because a magnetic switch 42 (shown in FIG. 3D) is off. The magnetic switch 42 is controlled by the eversible cover 14, the magnetic switch 42 will be on when the eversible cover 14 covers the tub 1 completely and be off when the eversible cover 14 opens. Once the magnetic switch 42 is on and the water level reaches to the predetermined water level, the pump 18 (as shown in FIGS. 2, 3A, 3C-3E) will start immediately. The water, mixed with some soap and antiseptic liquids, goes to all of the water jet nozzles with a wide spraying angle 22 (as shown in FIG. 3A) and the hydraulic massage water jet nozzles 26 (as shown in FIG. 3B), is jetted everywhere of the tub 1. The water jet will last a predetermined time, this time is controlled by the circuit controller 63 (as shown in FIG. 9E). The tub clean process will finish when this process lasts a predetermined time. The circuit controller 63 stops the pump 18, and opens the solenoid drain valve 39 (as shown in FIG. 3E). Conversely, as shown in FIG. 1, the walk-in bathtub with the prior art does not have this function because of shortage of the cover assembly shown in the present invention.

Thirdly, the user may press down a bath mode button 8 when he wants to take the bath. Usually, the users, especially the young users, just simply take a shower. But sometimes, they want to take the bath too, especially the old and infirm members in their family like to take the bath. So it is necessary that the multi-functional personal hygiene system is equipped with both a shower mode and a bath mode. Once the bath mode button 8 is pressed down, the multi-functional personal hygiene system will be on the bath mode. The bath mode will be cancelled and the multi-functional personal hygiene system goes back to the shower mode when the bath mode button 8 is pressed down again.

Fourthly, if the user wants to take the sauna, he may press down the SAUNA button 5 (shown in FIGS. 2, 3A, 3C, 3D and 9G). The sauna system includes a steam maker or a hot-air fan 65 (as shown in FIG. 9G) that is located in the immovable cover 4, a pipe 37 (as shown in FIG. 3E) that transports some steam or hot air into the tub 1, the sauna button 5 and the circuit controller 63 (as shown in FIG. 9E). After sitting on the built-in seat, closing and locking the access door 20 by turning the handle 21, the user can press down the SAUNA button 5 to start his sauna, then pulling out the sliding cover 13 and closing the eversible cover 14, the steam maker or hot-air fan 65 begins to work right away. The steam or hot air will go into the tub 1 along the pipe 37 (shown in FIG. 3 E) that connects the steam maker or hot-air fan 65 and the faucet 32 (as shown in FIG. 3C) of the tub 1. A temperature will be detected by the temperature sensor 38 and shown on the screen, and this temperature goes up instantly until reaching to a predetermined temperature, then the circuit controller 63 keeps this temperature. The user can finish his sauna by means of pressing the SAUNA button 5 again. It is very important that when the sauna system is working, the water jet button 6, the bath mode button 8, and the tub clean button 11 absolutely cannot work even if they have been pressed down carelessly.

As for the water jet system, it mainly comprises of the water inlet solenoid valve 36 (as shown in FIG. 3E), a water level gage 40 (as shown in FIG. 3E), the pump 18, the water jet nozzles with a wide spraying angle 22 (as shown in FIG. 3A), the hydraulic massage water jet nozzles 26 (as shown in FIG. 3B), a regulating valve 23 (as shown in FIG. 3A), a filter 30 (as shown in FIG. 3C), the circuit controller 63 (as shown in FIG. 9E), a faucet 32 (as shown in FIG. 3C), the temperature sensor 38 (as shown in FIG. 3E) and the solenoid drain valve 39 (as shown in FIG. 3E). In the example shown in FIG. 3B, four or more hydraulic massage water jet nozzles 26 are installed on the back wall of the tub 1 according to the present invention. These hydraulic massage water jet nozzles 26 jet the warm water on the user's body and legs, this process is similar to a hydraulic massage. The water jet nozzles with a wide spraying angle 22 are mounted on the wall of the closed space, and spray the warm water fog on the user's skins and aim at moisturizing and cleaning the skins.

Now, the user opens the access door 20, sits down on the built-in seat, turns his body 90 degrees. After sitting on the built-in seat, he closes and locks the access door 20 by turning the door lock handle 21. The user can press down the WATER JET button 6 to start his shower. If he wants to take a bath, he should press down the BATH MODE button 8 before pressing down the WATER JET button 6. Once the WATER JET button 6 is pressed down, the user may pull the sliding cover 13 out of the immovable cover 4 and close the eversible cover 14. The magnetic switch 42 will be on when the eversible cover 14 covers the tub 1 completely. The circuit controller 63 closes the solenoid drain valve 39, and opens the water inlet solenoid valve 36 immediately. After water passes the cold water line 35 and hot water line 34 (shown in FIG. 3E) and mixes, passes the water inlet solenoid valve 36 and a faucet 32 (shown in FIG. 3C), finally arrives in a tub pool. The cold water valve 2 and the hot water valve 3 is connected to its associated supply line 35 and 34 and controlled by the user to open and allow the water flow through the lines 35 and 34, or to close and stop the water flow through the lines 35 and 34. If the temperature sensor 38 (as shown in FIG. 3E) detects that the temperature of the water through the faucet 32 exceeds a predetermined temperature, the circuit controller 63 will shut up the water inlet solenoid valve 36 immediately, and open the drain solenoid valve 39, the media center 9 will show “alarm” on the screen. The filter 30 (as shown in FIG. 3C) is located at the bottom of the tub 1, before the inlet of the pump 18. The pump 18 is situated under the built-in seat and on a pedestal. Filtered water passes the pipe line 33 (as shown in FIGS. 3D and 3E) and arrives at the inlet of the pump 18. Some suction pipe lines connect the water jet nozzles to the outline 41. The pump 18 will start when the water level gage 40 detects that the water level arrives at a predetermined level, meanwhile, the warm water is jetted out of all the water jet nozzles. The regulating valve 23, which connects the inlet and outlet of the pump 18 by means of the pipe line, is adapted to adjust the pressure of the water jet nozzles. When the user feels that the water pressure is too high, he may open the regulating valve 23. Some of water coming from the pump will go back directly to the inlet of the pump. When he feels that the water pressure is too weak, he may close the regulating valve 23. The user may get a desirable jetting strength by turning the regulating valve 23. The temperature sensor 38 detects the water temperature and shows it on the screen 9. When this temperature drops, the circuit controller 63 will start the steam maker or hot-air fan 65 to make some steam or hot air, the steam or hot air will be sent into the tub pool and heats the water. When the water temperature goes up to the predetermined temperature, the circuit controller 63 will switch off the steam maker or hot-air fan 65, so the water temperature is always kept at the determined temperature. The magnetic switch 42 (as shown in FIG. 3D) is adapted to pause the multi-functional personal hygiene system, the magnetic switch 42 will be on when the sliding cover 13 and the eversible cover 14 cover the tub 1 completely, and off when the eversible cover 14 is pushed away. The water jet process may recover from the pause point instead of starting from the beginning when the sliding cover 13 and the eversible cover 14 cover the tub 1 completely again. If the user wants to finish the water jet, just opens the eversible cover 14 and press the WATER JET button 6 again. Once the water jet button 6 is pressed again, the solenoid drain valve 39 (shown in FIG. 3E) will be opened immediately by the circuit controller 63 (as shown in FIG. 9E) and the pump 18 will be switched off by the circuit controller 63. All the water in the multi-functional personal hygiene system will be drained completely. Similarly, it should be mentioned that all the operation on the SHOWER mode can be used on the bath mode.

As shown in FIGS. 2, 3A˜3E, a hand held shower head 12 is equipped on the top of the multi-functional personal hygiene system in accordance with a preferred embodiment of the present invention. This hand held shower head 12 is usually used for washing the user's head and face. Sometimes, it is used for cleaning the user's body with the clean water after the user takes a shower or bath with soap water as well. It is simply used for cleaning the tub 1 as well. It should be mentioned that when the water jet system is working, the sauna button 5, the bath mode button 8 and the tub clean button 11 absolutely cannot work even if they have been pressed down carelessly. The massage button 7 does or does not work according to the user's desire during the water jet system working.

A massage & scrub disk assembly 16 (shown in FIGS. 2, 3A˜3D, more detailed in FIGS. 10A˜10C) is mounted on the wall of the seating area of the tub 1 and used for massaging and cleaning the user's back. This massage & scrub disk assembly includes a hard and strong disk 77 (best shown in FIG. 10C), a belt 71, a disk cover 72 made of the non-metal material with various kinds and sizes of bulges on the disk cover surface, these bulges are very smooth, and made of plastic, composite material, stone or wood; a shaft that connects the disk 77 and a belt wheel 73, a shaft installing sleeve 76 and the nuts 74, 75. The nut 75 fastens tightly the shaft installing sleeve 76 on the wall of the tub 1, the nut 74 fastens the disk 77 in the shaft installing sleeve 76. The disk 77 is driven by a massage motor 70 (shown in FIGS. 10A and 10B) installed on a support frame 17 (shown in FIG. 2, 3A˜3E) and rotates alternatively on the clockwise and counter clockwise at a low speed. The user can randomly start this disk by pressing down the massage button 7 that situates on the top of the immovable cover 4. It should be mentioned that the massage & scrub disk assembly may work together with the sauna system, the water jet system, or the tub clean system, it may work alone as well.

It should be noted that only one massage and scrub assembly 16 is equipped on the multi-functional personal hygiene system (shown in FIG. 2, 3A˜3D) of the example embodiment of the present invention. Actually, at least one massage & scrub disk assemblies may be applied on the multi-functional personal hygiene system of the present invention.

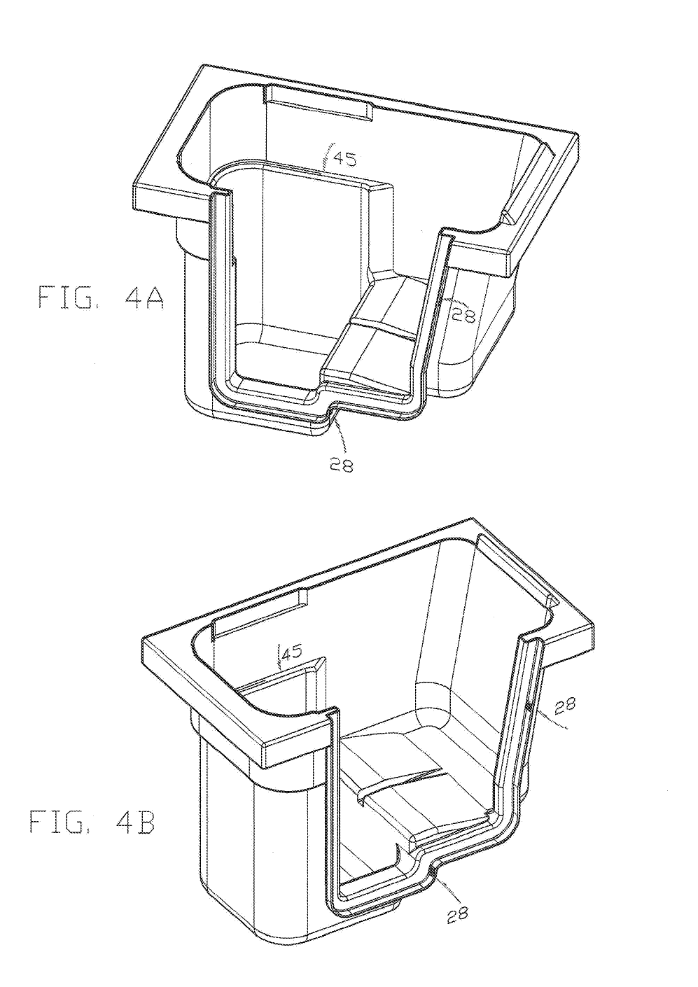

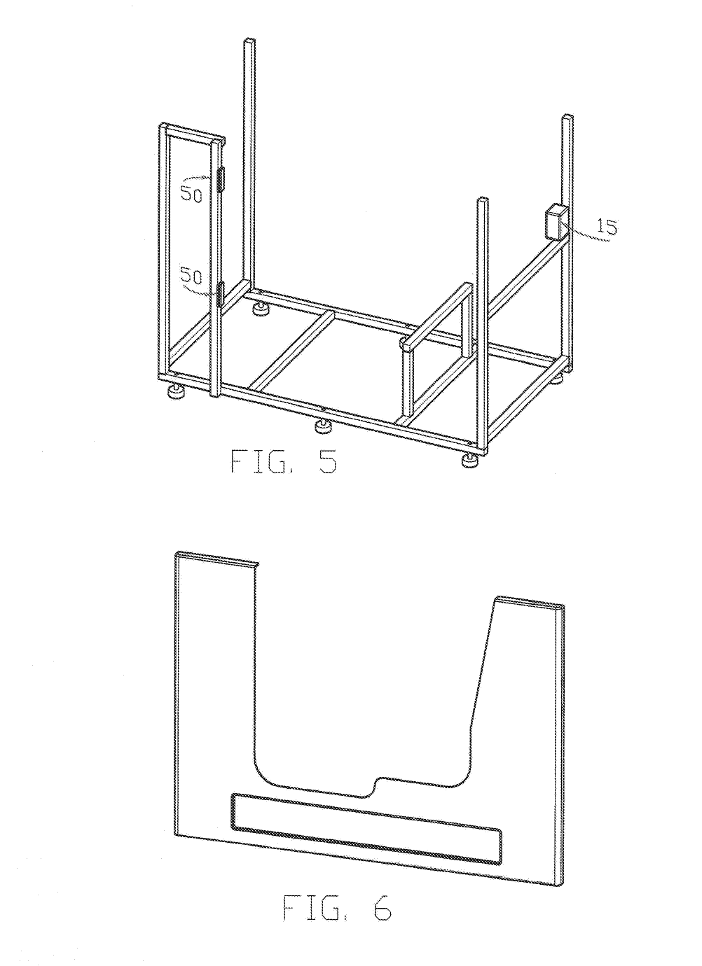

FIGS. 4A and 4B show a tub 1 that does not utilize a door frame around the threshold of the present invention. Unlike the walk-in bathtub of the prior art design, the back place of the tub bottom in the present invention is raised to form a built-in seat, the front place is a water pool for containing the warm water. In addition, a step 45 (best shown in FIGS. 4A and 4B) is formed on the upstanding sidewall. This step is used for supporting the immovable cover 4. The width of the tub below the step 45 is smaller than the width of the tub above the step. There are two holes 28 for the door lock pin on the tub 1. It should be noted that the present invention can also be used with the tub that utilizes a door frame around the threshold, no matter the outward swinging access door opens forward or backward, on the left side or right side.

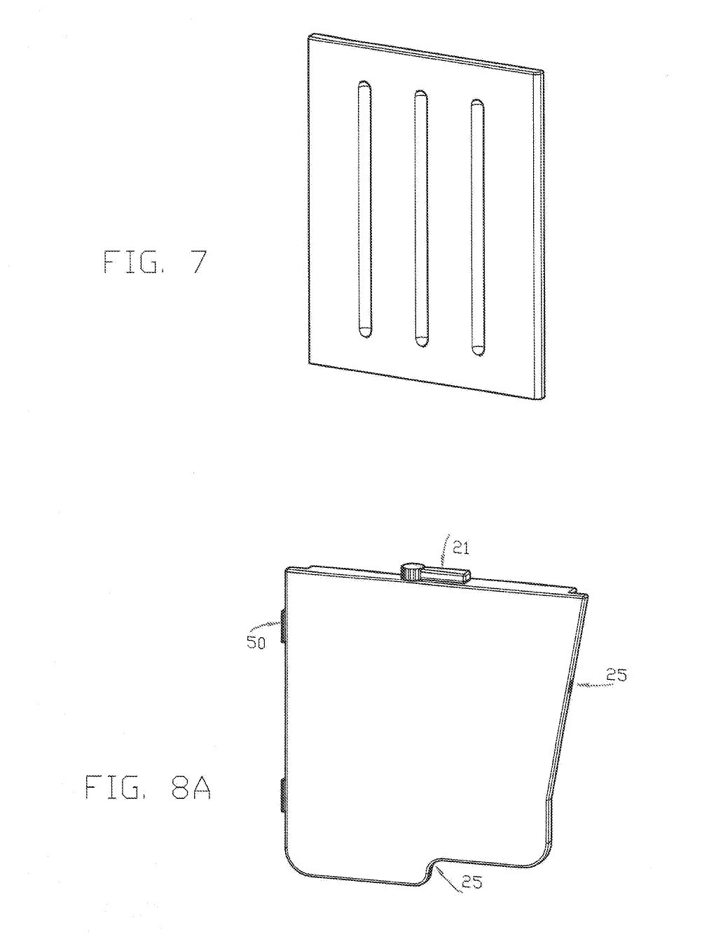

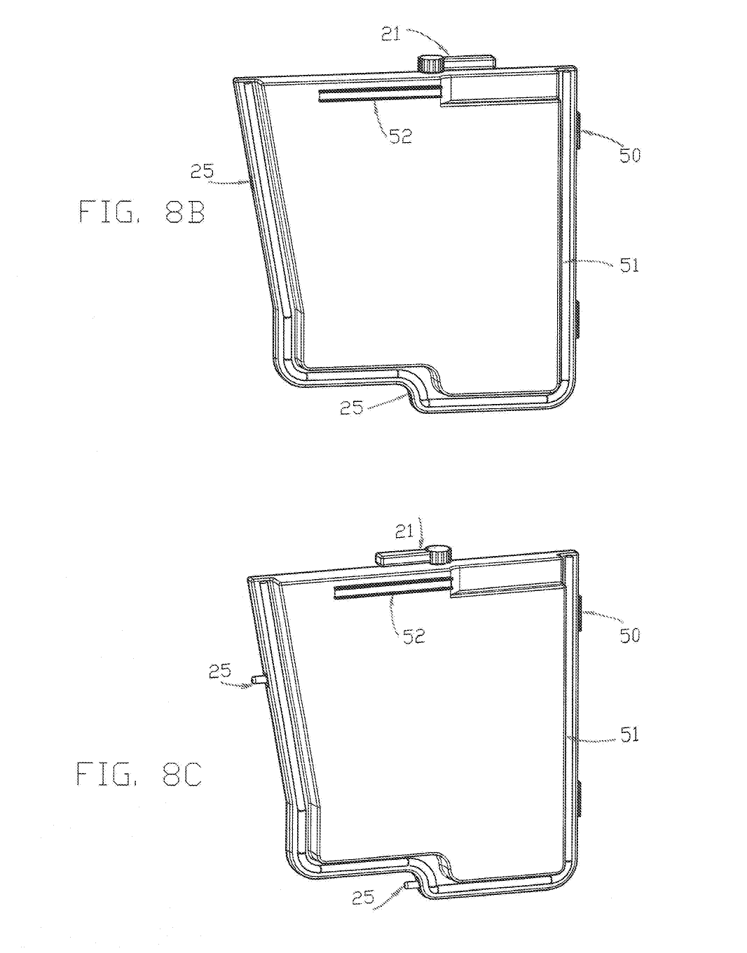

In the example shown, FIGS. 8A˜8C show the access door 20 with a set of lock 21. The access door 20 is connected to the support frame 17 by an intermediate double axis hinge 50, the double axis hinges 50 are fastened on the access door by some screws, meanwhile, the double axis hinge 50 are fastened on the support frame 17 (as shown in FIG. 5) through the door threshold. A set of door lock 21 is equipped on the access door 20, both door lock pins 25 come out of the access door 20 when the door lock handle 21 is turned 180 degrees (as shown in FIG. 8C). A track 52 is used for the sliding cover 13 to slide inside. However, it should be mentioned that the present invention can also be used with the tub 1 that utilizes a door frame around the threshold.

As you know, it is very important that the choice of seal between the access door 20 and the threshold. Like the prior art design, a sealing strip 51 (as shown in FIGS. 8B and 8C) is used for sealing between the access door 20 and the threshold in the present invention.

Unlike the prior art design, FIGS. 9A˜9G show the cover assembly that is equipped on the top of the tub 1 of the present invention, it is formed by plastic, composite material or wood, and comprises the sliding cover 13, the eversible cover 14 and the immovable cover 4. For watching how the multi-functional personal hygiene system works, the sliding cover 13 and eversible cover 14 may be made of a transparent material. The steam maker or hot-air fan 65, the circuit controller 63, a louder speaker 64, and the media center 9 are installed in the immovable cover 4 (as shown in FIG. 9A-9G), some small plastic wheels 62 are used for the sliding cover 13 to move in the track 24 smoothly. The eversible cover 14 is connected to the sliding cover 13 by means of a couple of hinge 60. The sliding cover 13 can be pulled out of the immovable cover 4 so as to cover the tub 1. The cover assembly is mounted on the tub 1 (as shown in FIG. 2,3A˜3E), some bolts are adapted to connect the immovable cover 4 to the tub 1. Some sealing strips 6i are adapted to seal between the tub 1 and the cover assembly.

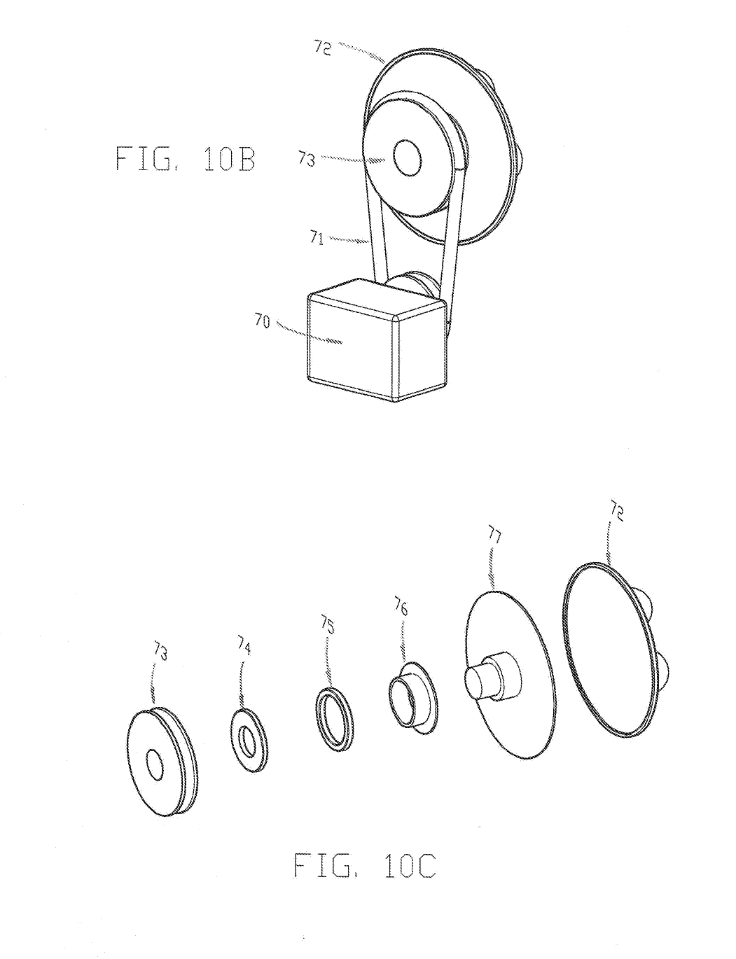

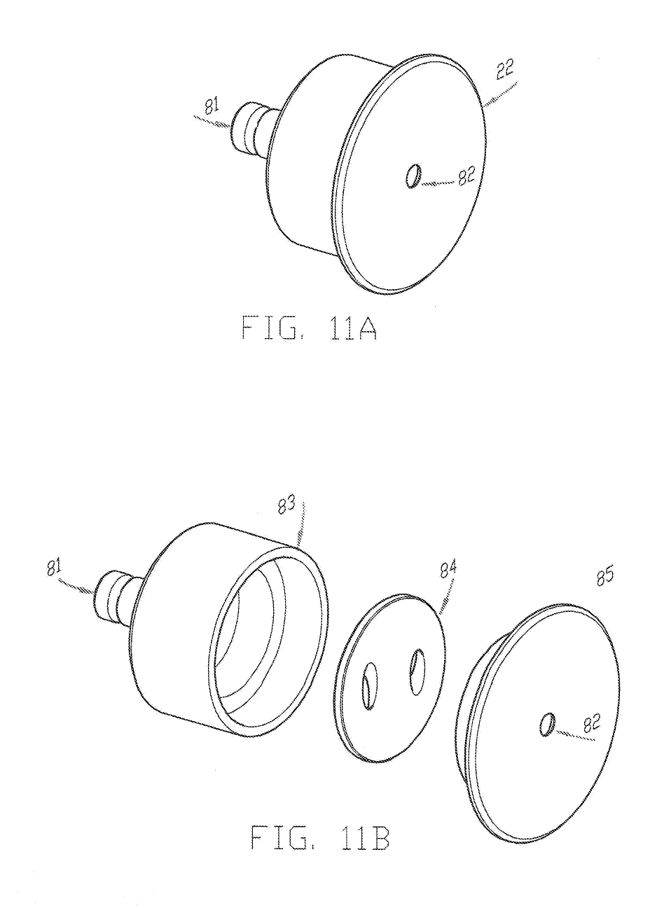

FIGS. 11A and 11B show a representative water jet nozzle with a wide spraying angle 22 equipped on the multi-functional personal hygiene system of the present invention. This water jet nozzle with a wide spraying angle includes a shell 83 with an inlet 81, a disk with two holes 84 and a cover 85 with a small outlet 82. The disk 84 separates the nozzle into a front room and a behind room. The pressured water coming from the pump 18 goes into the behind room of the jet nozzle 22, the water flow begins to revolve rapidly in the front room of the nozzle after passing through the two holes of the disk 84. The pressured water becomes a lot of tiny or small size of water drops when coming out of the outlet 82 of the water jet nozzle with a wide spraying angle 22.

FIG. 12 shows a representative flow chart of a multi-functional personal hygiene system in accordance with a preferred embodiment of the present invention.

All the six control buttons are waterproof and have their indicating lights, when they are pressed down, their lights will be turned on, means “switch on”; when pressed again, their lights will be turned off, means “switch off”.

Referring now to the flow chart (shown in FIG. 12), describe the working process of the multi-functional personal hygiene system.

First of all, switch on the multi-functional personal hygiene system by pressing the power button 10. Its light is turned on, and the media center 9 starts, meanwhile, the temperature sensor 38 detects the temperature in the tub 1, and this temperature value is shown on the screen, the user may search for all the information in the media center 9, the videos and audios may be played in the media center 9.

Secondly, the tub clean system may be started if needed. The user closes and locks the access door 20, pulls the sliding cover 13 out of the immovable cover 4, and closes the eversible cover 14 completely. When the tub clean button 11 is pressed down, its light will be turned on, the circuit controller 63 shuts up the solenoid drain valve 39 (normally opened) and opens the water inlet solenoid valve 36 (normally closed), the warm water goes into the tub 1 through the faucet 32. The alarm will be on and the water inlet solenoid valve 36 will be shut up and the solenoid drain valve 39 will be opened if the water temperature exceeds the predetermined temperature. The circuit controller 63 will close the water inlet solenoid valve 36 when the water level gage 40 detects that the water level reaches at the predetermined level. The tub clean system will be on the “pause” condition if the eversible cover 14 opens. Once the eversible cover 14 is closed, the magnetic switch 42 (shown in FIG. 3D) will be switched on. The pump 18 starts and the water jets from all the water jet nozzles 22 and 26. When the tub clean system works a predetermined time, the circuit controller 63 will shut the pump 18 and open the solenoid drain valve 39, the indicating light of the tub clean button 11 will be switched off, the tub clean process finishes.

Thirdly, when the sauna button 5 is pressed down, its indicating light will be turned on. The circuit controller 63 starts the steam maker or hot-air fan 65, the temperature in the tub 1 rises and is shown on the media center 9, when the temperature reaches at the predetermined temperature, the circuit controller 63 stops the steam maker or hot-air fan 65. When the temperature drops, the steam maker or hot-air fan 65 will start again. By doing so, the temperature in the tub 1 is always kept at the predetermined temperature. The user can press down the sauna button 5 again to stop the sauna system when he wants to finish his sauna, its light will be turned off when the sauna button 5 is pressed down again.

Fourthly, when the water jet button 6 is pressed down, its indicating light will be turned on. The circuit controller 63 closes the solenoid drain valve 39 (normally opened); meanwhile, opens the water inlet solenoid valve 36 (normally closed). The warm water goes into the tub 1, the alarm will be on and the water inlet solenoid valve 36 will be shut up and the solenoid drain valve 39 will be opened if the water temperature exceeds a predetermined temperature. The water inlet solenoid valve 36 will be shut up by the circuit controller 63 when the water level gage 40 detects that water level reaches at a lower predetermined water level. This lower predetermined water level is under the seat of the tub 1. If the eversible cover 14 opens, the water jet system will be on the “pause” condition. Once the eversible cover 14 is closed completely, the magnetic switch 42 (shown in FIG. 3D) will be on. The pump 18 starts and the water jets from all the water jet nozzles, the desired pressure of the water may be gotten by means of turning a pressure regulating valve 23. The user may break the water jet by means of opening the eversible cover 14 or finish the water jet by means of pressing down the water jet button 6 again. Once the water jet button 6 is pressed down again, the circuit controller 63 shuts the pump 18 and opens the solenoid drain valve 39 immediately, the light of the water jet button 6 is switched off too.

When the user wants to take a bath, he should press down the bath mode button 8 firstly, the hygiene system will work on the bath mode, then press down the water jet button 6. Once the water jet button 6 is pressed down, the circuit controller 63 closes the solenoid drain valve 39 (normally opened); meanwhile, opens the water inlet solenoid valve 36 (normally closed). The warm water goes into the tub 1, the alarm will be on and the water inlet solenoid valve 36 will be shut up and the solenoid drain valve 39 will be opened if the water temperature exceeds the predetermined temperature. The water inlet solenoid valve 36 will be shut up by the circuit controller 63 when the water level reaches at a higher predetermined water level. If the eversible cover 14 opens, the water jet system will be on the “pause” condition. Once the eversible cover 14 is closed, the magnetic switch 42 will be on. The pump 18 starts and the water jets from all the water jet nozzles, the desired pressure of the water may be gotten by means of turning a pressure regulating valve 23. The user may break the water jet by means of opening the eversible cover 14 or finish the water jet by means of pressing down the water jet button 6 again. Once the water jet button 6 is pressed down again, the circuit controller 63 shuts the pump 18 and opens the solenoid drain valve 39 immediately, the light of the water jet button 6 is switched off too. The user may open a manual drain valve 31 (shown in FIG. 3C) to drain the water quickly when the circuit controller 63 opens the solenoid drain valve 39 because there are many water in the tub 1 on the bath mode.

Finally, when the massage button 7 is pressed down, its light will be turned on. A belt 71 connects the massage motor 70 and the disk 72. The massage motor 70 drives the massage & scrub disk 72, the massage & scrub disk 72 alternatively rotates on the clockwise and counter clock wise, at a speed of 5˜7 revs per minute, exchanges the rotation direction about every half minute. The disk will stop when the massage button 7 is pressed down again.

It should be mention that:
a. When the tub clean button 11 works, other buttons cannot work;
b. When the sauna button 5 works, the massage button 7 can work at the same time, the tub clean button 11, the water jet button 6 and the bath mode button 8 cannot work;
c. When the water jet button 6 works, the massage button 7 can work at the same time, the tub clean button 11, the sauna button 5 and the bath mode button 8 cannot work;
d. When the bath mode button 8 is pressed down, its light will be turned on. The multi-functional personal hygiene system will be on the bath mode. When the water jet button 6 is pressed down, the water level will reach at a higher predetermined level. The massage button 7 can work, and the sauna button 5 and the tub clean button 11 cannot work.

The description of the present invention has been presented for purpose of illustration, and is not intended to be exhaustive or limited to the invention in the form disclosed. Many modification and variation will be apparent to those of ordinary skill in the art. The embodiment was chosen and described in order to best explain the principals of the present invention, and to enable others of ordinary skill in the art to understand the invention for various embodiments with various modifications as are suited to the particular use contemplated. It will be understood by one of the ordinary skill in the art that numerous variations will be possible to the disclosed embodiments without going outside the scope of the invention as disclosed in the claims.

I claim:

1. A multi-functional personal hygiene system, the multi-functional personal hygiene system comprises:
(a) A tub that is for user to take a sauna, a shower, a bath and a massage;
(b) An access door that allows user to enter and exit the tub;
(c) A cover assembly that is used for covering the tub, meanwhile, keeping the user's head outside the cover assembly;
(d) At least one massage & scrub disk assemblies that provides a mechanical massage;
(e) A support frame that holds up the tub, a pump and a massage motor;
(f) A sauna system that is adapt to increase a temperature inside the tub when user takes the sauna, and keep the water in the tub at a predetermined temperature when user takes the shower or the bath, by means of pouring some steam or hot-air therein;
(g) A water jet system that is adapted to wash the user's body and head, and provide the user a hydraulic massage;
(h) A bath mode that allows the user to take the bath;
(i) A media center that saves some information about the multi-functional personal hygiene system and supplies the user some audio and video entertainments;
(j) A tub clean system that is used for cleaning and sanitizing the tub automatically;
(k) A circuit controller that controls the sauna system, the water jet system, the at least one massage & scrub disk assemblies, the bath mode and the tub clean system;
(l) A leakage current circuit breaker that switches off the multi-functional personal hygiene system immediately in case of leakage of electricity.

2. The multi-functional personal hygiene system according to claim 1, wherein said tub, the access door and the cover assembly create a closed space where the sauna system, the water jet system, the at least one massage & scrub disk assemblies and the tub clean system perform.

3. The multi-functional personal hygiene system according to claim 1, wherein said cover assembly is made of plastic, composite material or wood, comprises an immovable cover, an eversible cover and a sliding cover.

4. The multi-functional personal hygiene system according to claim 3, wherein,
(a) Said immovable cover contains a steam maker or a hot-air fan and the media center;
(b) Said eversible cover connects the sliding cover by a hinge;
(c) Said sliding cover and eversible cover may be pulled out of the immovable cover and pushed into the immovable cover;
(d) Some sealing strips are adapted to seal all gaps between the cover assembly and the tub.

5. The multi-functional personal hygiene system according to claim 1, wherein the water jet system includes,
(a) A body washing system that contains:
(i) the pump;
(ii) a water inlet solenoid valve;
(iii) a pressure regulating valve;
(iv) a water level gage;
(v) some water jet nozzles;
(vi) a solenoid drain valve;
(vii) a filter;
(viii) some pipes;
(ix) the circuit controller;
(b) A head and face washing sub-system that consists of a hand held shower head and a valve for the hand held shower head.

6. The multi-functional personal hygiene system according to claim 5, wherein said water jet nozzles comprising:
(a) Some water jet nozzles with a wide spraying angle;
(b) Some hydraulic massage water jet nozzles.

7. The multi-functional personal hygiene system according to claim 6, wherein the water jet nozzles are mounted on the wall of the closed space.

8. The multi-functional personal hygiene system according to claim 5, said solenoid drain valve is used for draining the water when opened by the circuit controller or retaining the water in the tub when closed by the circuit controller.

9. The multi-functional personal hygiene system according to claim 1, wherein the sauna system comprises,
(a) The steam maker or the hot-air fan;
(b) Some pipes that connects the steam maker or hot-air fan to the tub;
(c) The circuit controller;
(d) A sensor that senses the temperature in the tub.

10. The multi-functional personal hygiene system according to claim 9, wherein said steam maker or hot-air fan,
(a) Supplies the enough steam or hot air for the sauna system;
(b) Heats the water in the tub and keeps the water warm by pouring the steam or hot air into the water.

11. The multi-functional personal hygiene system according to claim 1, wherein,
(a) The at least one massage & scrub disk assemblies includes:
(i) a disk made of non-corrosive material;
(ii) the massage motor that drives the disk;
(iii) a shaft that connects the disk and the massage motor, and made of non-corrosive material;
(iv) the circuit controller that controls the disk to rotate alternately at a low speed on clockwise and counter clockwise;
(b) The at least one massage & scrub disk assemblies is installed on the wall of a seating area of the tub and driven by the massage motor that hidden behind the wall of the tub, and massages and cleans the user.

12. The multi-functional personal hygiene system according to claim 11, some various kinds and sizes of massage bulges are distributed on the disk surface, these massage bulges are made of plastic, composite material, stone or wood.

13. The multi-functional personal hygiene system according to claim 1, wherein,
(a) The circuit controller controls the sauna system, the water jet system, the at least one massage & scrub disk assemblies, the bath mode and the tub clean system;
(b) The sauna system, the water jet system, the at least one massage & scrub disk assemblies and the tub clean system may work alone;
(c) The sauna system and the at least one massage & scrub disk assemblies may work at the same time;
(d) The water jet system, the at least one massage & scrub disk assemblies and the bath mode may work at the same time;
(e) The water jet system and the at least one massage & scrub disk assemblies may work at the same time;
(f) The at least one massage & scrub disk assemblies and the tub clean system may work at the same time;
(g) The water jet system and the bath mode may work at the same time;
(h) Both the water jet system and the tub clean system may pause when the eversible cover is opened, and continue to work from the pause point when the eversible cover is closed.

14. The multi-functional personal hygiene system according to claim 1, wherein,
(a) The water jet system works on the bath mode when the bath mode is selected by the user;
(b) The water jet system works on a shower mode when the bath mode is not selected by the user;
(c) The bath mode allows the user to dip his body into the water in the tub completely;
(d) The shower mode allows the user to take less water and wash his body rapidly. The water level in the tub on the shower mode is under the seat of the tub.

15. The multi-functional personal hygiene system according to claim 1, wherein,
(a) The media center contains:
(i) a screen that shows the information;
(ii) a loud speaker;
(iii) a media player that plays some audios and videos;
(b) The media center saves the information about the multi-functional personal hygiene system.

16. The multi-functional personal hygiene system according to claim 1, wherein,
(a) The tub clean system consists of:
(i) the pump;
(ii) the water inlet solenoid valve;
(iii) the pressure regulating valve;
(iv) the water level gage;
(v) the water jet nozzles;
(vi) the solenoid drain valve;
(vii) the filter;
(viii) the pipes;
(ix) the circuit controller;
(b) The time which the tub clean system works is controlled by the circuit controller.

17. The multi-functional personal hygiene system according to claim 1, the following features are optional:
(a) The sauna system;
(b) The water jet system;
(c) The at least one massage & scrub disk assemblies;
(d) The bath mode;
(e) The tub clean system;
(f) The media center;
(g) Memory setting for personal preference.
